(19) United States
(12) Patent Application Publication
(10) Pub. No.: US 2020/0267475 A1
(43) Pub. Date: Aug. 20, 2020

(54) LOUDSPEAKER AND DIAPHRAGM UNIT

(71) Applicant: Panasonic Intellectual Property Management Co., Ltd., Osaka-shi, Osaka (JP)

(72) Inventors: Kazuyuki Kosuda, Okayama (JP); Yuji Matsuo, Okayama (JP); Yuichi Kobayashi, Okayama (JP); Yasuhiro Makino, Okayama (JP)

(73) Assignee: Panasonic Intellectual Property Management Co., Ltd., Osaka-shi, Osaka (JP)

(21) Appl. No.: 16/755,055

(22) PCT Filed: Sep. 18, 2018
(86) PCT No.: PCT/JP2018/034529

§ 371 Date: Apr. 9, 2020

(30) Foreign Application Priority Data
Oct. 19, 2017 (JP) 2017-202963

(51) Int. Cl. H04R 7/18; H04R 9/02; H04R 1/10

(52) U.S. Cl. CPC H04R 7/18; H04R 1/1016; H04R 9/025

(57) ABSTRACT

A loudspeaker (100) includes a magnetic circuit (110) having a magnetic gap (111); a voice coil body (120) disposed in the magnetic gap (111) in an inserted state; a diaphragm (130) to which the voice coil body (120) is attached; a frame (140) to which the outer circumferential, portion of the diaphragm (130) and the magnetic circuit (110) are attached; a vibration preventing member (150) including a viscoelastic body attached to the outer circumferential, portion of the diaphragm (130) in an annular shape; and a holding member (160) having an annular shape and sandwiching the outer circumferential portion of the diaphragm (130) and the vibration preventing member (150) between the frame (140) and the holding member.

### TECHNICAL FIELD

The present disclosure relates to a loudspeaker used in earphones and the like, and a diaphragm unit as a component of the loudspeaker.

### BACKGROUND ART

PTL 1 discloses an earphone which includes a diaphragm having an outer circumferential portion between a port and a box which form a housing, the outer circumferential portion being pressure welded to the housing and fixed with an adhesive. The adhesive also functions as a seal for sealing the gap between the port and the box to prevent air leakage (sound leakage) to the outside of the housing from the bonding portion.

### CITATION LIST

### Patent Literature

PTL 1: WO2013/114864

### SUMMARY OF THE INVENTION

### Technical Problems

However, in some cases, the adhesive may unintentionally squeeze out toward the inner circumferential portion of the diaphragm and solidify in such a state because the port is assembled to the box after the application of the adhesive between the port and the box. In such a state, the rigidity of the adhesive impairs the softness needed for the outer circumferential portion of the diaphragm to affect the acoustic properties and distortion properties of the loudspeaker. Because it is difficult to control the amount of the adhesive to squeeze out, fluctuations in acoustic properties and distortion properties are generated in a plurality of earphones. Such influences of the adhesive on the acoustic properties and the distortion properties are demonstrated more remarkably as the outer circumferential portion of the diaphragm has a thinner thickness.

Moreover, in the outer circumference of the diaphragm fixed with the adhesive between the port and the box, the bonding portion serves as a fixed end for vibration. As a result, the vibration energy generated during driving of the earphone is directly transmitted to the housing to induce the co-vibration of the housing, which gives adverse effects on the distortion properties of the earphone.

An object of the present disclosure is to provide a loudspeaker and a diaphragm unit which prevent sound leakage from the outer circumferential portion of a diaphragm and reduce the vibration transmitted to a frame and the like.

### Solutions to Problems

One of the loudspeakers according to the present disclosure includes a magnetic circuit having a magnetic gap; a voice coil body disposed in the magnetic gap in an inserted state; a diaphragm to which the voice coil body is attached; a frame to which an outer circumferential portion of the diaphragm and the magnetic circuit are attached; a vibration preventing member including a viscoelastic body attached to the outer circumferential portion of the diaphragm in an annular shape; and a holding member having an annular shape and sandwiching the outer circumferential portion of the diaphragm and the vibration preventing member between the frame and the holding member.

The diaphragm unit according to the present disclosure includes a diaphragm included in a loudspeaker; a vibration preventing member including a viscoelastic body attached to an outer circumferential portion of the diaphragm in an annular shape; and an edge protector attached to the outer circumferential portion of the diaphragm, the edge protector being annular and more rigid than the diaphragm.

### Advantageous Effect of Invention

The loudspeaker according to the present disclosure, although it is even a loudspeaker including a compact and thin diaphragm, can minimize the influences over acoustic properties and the like caused by protrusion of a vibration preventing member toward the diaphragm, and can reduce the co-vibration of a frame and the like in a fixed portion of the diaphragm, which is caused by absorption of vibration by the vibration preventing member.

### BRIEF DESCRIPTION OF DRAWINGS

FIG. 1 is a sectional view illustrating the loudspeaker according to Embodiment 1.

FIG. 2 is a perspective view illustrating an earphone including the loudspeaker according to Embodiment 1.

FIG. 3 is a sectional view illustrating a portion where the diaphragm according to Embodiment 1 is attached to a frame.

FIG. 4 is a table showing the properties of the vibration preventing member according to Embodiment 1.

FIG. 5 is a graph showing the sound pressure frequency properties of the loudspeaker according to Embodiment 1,

FIG. 6 is a graph showing the harmonic distortion properties of the loudspeaker according to Embodiment 1.

FIG. 7 is a sectional view illustrating the diaphragm unit according to Embodiment 2.

FIG. 8 is a sectional view illustrating a variation of the positional relation among the diaphragm, the edge protector, and the vibration preventing member between the frame and the holding member.

FIG. 9 is a sectional view illustrating another variation of the positional relation among the diaphragm, the edge protector, and the vibration preventing member between the frame and the holding member.

FIG. 10 is a sectional view illustrating a variation of the diaphragm unit.

### DESCRIPTION OF EXEMPLARY EMBODIMENTS

### Embodiment 1

The loudspeaker according to one aspect of the present disclosure will now be described in detail with reference to the drawings.

The embodiments to be described below only show specific examples of the present disclosure. Numeral values, shapes, materials, components, arrangements, positions, and connection forms of the components, steps, order of the steps, and the like shown in the embodiments below are only examples, and will not limit the present disclosure. Moreover, among the components of the embodiments below, the components not described in an independent claim representing the most superordinate concept of the present disclosure will be described as arbitrary components.

The drawings are schematic views subjected to appropriate emphasis or omission and adjustment of ratios in order to illustrate present disclosure, and may be different from actual shapes, positional relations, and ratios in some cases.

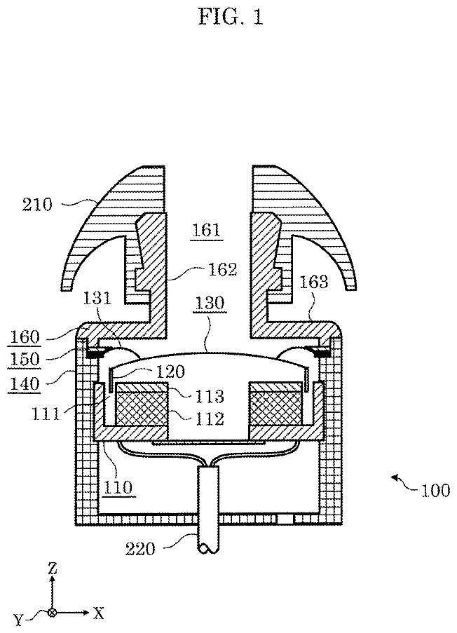

FIG. 1 is a sectional view illustrating the loudspeaker according to an embodiment.

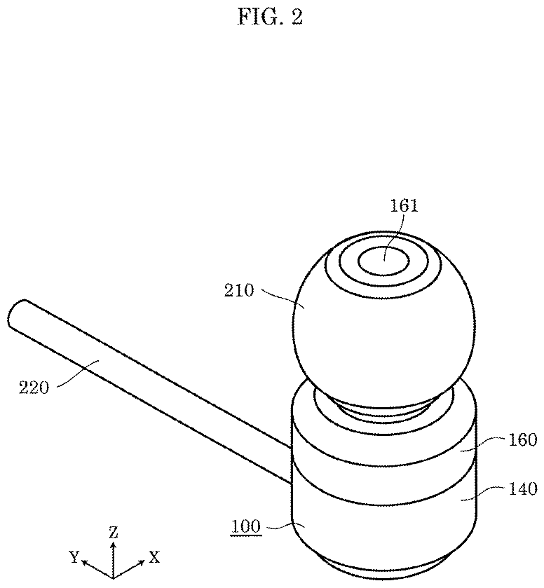

As illustrated in the drawing, loudspeaker 100 is an electric acoustic converter which converts an input electric signal to a sound and radiates the sound, and includes magnetic circuit 110, voice coil body 120, diaphragm 130, frame 140, vibration preventing member 150, and holding member 160. In the case of the present embodiment, loudspeaker 100 is included in a canal earphone as illustrated in FIG. 2, and further includes ear chip 210 and cable 220. In loudspeaker 100, the radiating direction of the sound from loudspeaker 100 (the positive direction of the Z-axis in the drawing) is described as the front, and the opposite direction. (the negative direction of the Z-axis in the drawing) is described as the hack in some cases.

Ear chip 210 is detachably attached to loudspeaker 100 so as to be fitted thereto. Ear chip 210 is a member for disposing the earphone inside the human ear canal. Ear chip 210 is made of a soft resin, for example, to flexibly correspond to the shape of the human ear canal.

Cable 220 is a coated electric wire for inputting an electric signal to loudspeaker 100. Specifically, cable 220 is connected to a substrate (not illustrated) disposed inside loudspeaker 100 in the state where cable 220 penetrates through a through hole disposed in loudspeaker 100.

Magnetic circuit 110 generates a steady state magnetic flux which acts on a magnetic flux which changes based on an electric signal input to voice coil body 120. Magnetic circuit 110 is attached to frame 140 to be located posterior to diaphragm 130, and includes magnetic gap 111 which has an annular shape and faces diaphragm 130. Magnetic gap 111 is an annular gap where the steady state magnetic flux is generated in a direction orthogonal to the magnetic flux generated in voice coil body 120.

In the case of the present embodiment, magnetic circuit 110 is of an internal magnet type, and includes cylindrical magnet 112 which is magnetized, top plate 113 which has an annular shape and is disposed on a surface of magnet 112 on the side of diaphragm 130, and bottomed cylindrical yoke 114 which accommodates magnet 112 and top plate 113 and has a wall elevating up to top plate 113. Although a through hole for passing the air flow which generates posterior to diaphragm 130 is disposed in the center of magnetic circuit 110, the through hole may be eliminated. Magnetic circuit 110 may be an magnetic circuit of an external magnet type.

One end of voice coil body 120 is disposed inside magnetic gap 111 of magnetic circuit 110, and the other end thereof is attached to diaphragm 130. Voice coil body 120 generates a magnetic flux based on the electric signal to be input, and vibrates in the winding axis direction (in the Z-axis direction in the drawing) as a result of interaction with magnetic circuit 110.

The winding axis (central axis) of voice coil body 120 is disposed in the direction (in the Z-axis direction in the drawing) of vibration (amplitude) of diaphragm 130, and is orthogonal to the direction of the magnetic flux inside magnetic gap 111.

In the case of the present embodiment, voice coil body 120 is a coil prepared by winding a single metallic wire material several times into loops (into a cylindrical shape). Voice coil body 120 is attached to the outer circumferential portion of diaphragm 130. Voice coil body 120 may include a bobbin around which the coil is wound. The bobbin is a tubular member made of a material such as aluminum or a resin.

Diaphragm 130 is a member to which voice coil body 120 is connected. Diaphragm 130 displaces forward and backward with the respect to the neutral position (in the Z-axis direction in the drawing) based on the vibration of voice coil body 120 to vibrate air, thereby generating a sound. In the case of the present embodiment, diaphragm 130 has a so-called domed shape which has a diameter gradually increasing from the front side (the positive side of the Z-axis in the drawing) toward the back side. The outer circumferential portion of diaphragm 130 has a branched shape including a portion connected to voice coil body 120 and edge 131 made of a thin film connected to frame 140.

Diaphragm 130 can be made of any material without limitation. Examples thereof include paper and resins.

In the case of the present embodiment, edge 131 is a thin film having a thickness of 100 micrometers or less, and may be a thin film of 10 micrometers or less. Edge 131 is made of a material having flexibility and resilience, such as a resin. Edge 131 can have any shape. Because edge 131 supports diaphragm 130 such that the reciprocal movement of diaphragm 130 is allowed, edge 131 has a curved portion projecting in at least one of the forward and backward directions, and the outer circumferential portion of the curved portion has an outermost circumferential portion in the form of an annular thin plate. Diaphragm 130 is held by frame 140 at the outermost circumferential portion.

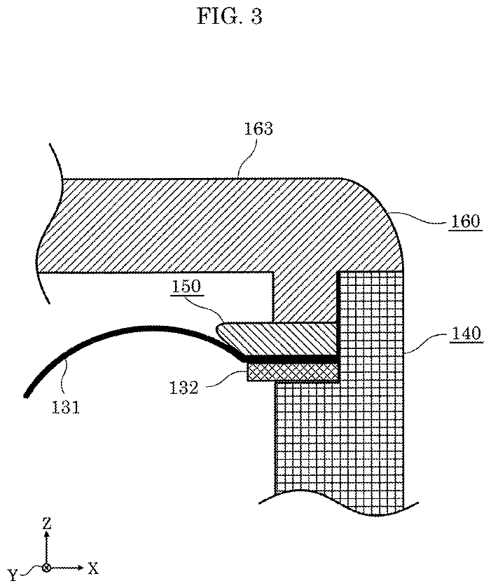

In particular, for edge 131 to guarantee the structural strength of diaphragm 130 and facilitate the handling of diaphragm 130, edge protector 132 having an annular shape is attached to the rear surface of edge 131, which is the outer circumferential portion of diaphragm 130 (see FIG. 3). Edge protector 132 is made of a material, such as paper impregnated with a resin, to have an annular shape corresponding to the shape of the outermost circumferential portion of diaphragm 130.

Diaphragm 130 is fixedly attached to frame 140 and the adhesive. Specifically, edge protector 132 is bonded to frame 140, and edge protector 132 is bonded to the outermost circumferential portion of diaphragm 130 with an adhesive.

Frame 140 is a structural member which fixedly holds edge 131 as the outer circumferential portion of diaphragm 130 and fixedly holds magnetic circuit 110. In the case of the present embodiment, frame 140 forms a housing which has a bottomed box shape and accommodates magnetic circuit 110 and voice coil body 120. The opening thereof is covered with diaphragm 130. In other words, in the case of the present embodiment, frame 140 is a structural member which holds magnetic circuit 110 and diaphragm 130 with a predetermined positional relation, and also functions as an enclosure which processes sounds generated posterior to diaphragm 130. Frame 140 can be made of any material. Examples thereof include metals and resins.

Holding member 160 is an annular member which sandwiches the outermost circumferential portion of edge 131 or the outer circumferential portion of diaphragm 130 and vibration preventing member 150 between frame 140 and holding member 160. In the case of the present embodiment, loudspeaker 100 constitutes an earphone to be put on an ear. For this reason, holding member 160 constitutes a port which has sound path 161 for guiding a sound to the ear in a direction anterior to diaphragm 130. Holding member 160 also includes annular fitting portion 163 fitted into frame 140, and cylindrical attachment 162 to which ear chip 210 is attached.

Vibration preventing member 150 includes a viscoelastic body attached in an annular shape to the outermost circumferential portion of edge 131 which is the outer circumferential portion of diaphragm 130. Vibration preventing member 150 is sandwiched between frame 140 and holding member 160, and is filled into the gap between frame 140 and holding member 160 to prevent the leakage of the sound from the gap. Furthermore, vibration preventing member 150 includes a viscoelastic body. By shear deformation of its own, vibration preventing member 150 controls the vibration of diaphragm 130 during driving of loudspeaker 100 to prevent transmission of the vibration to frame 140 and holding member 160.

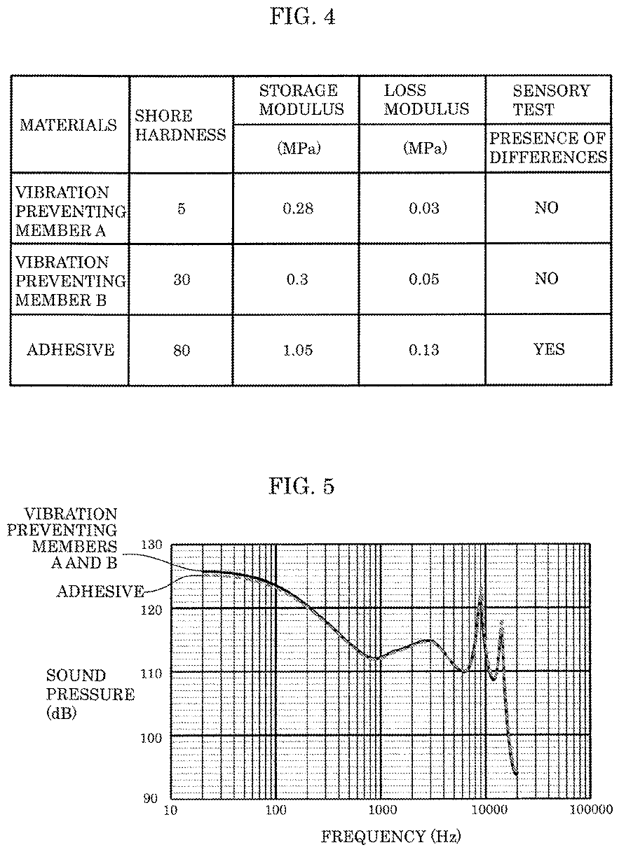

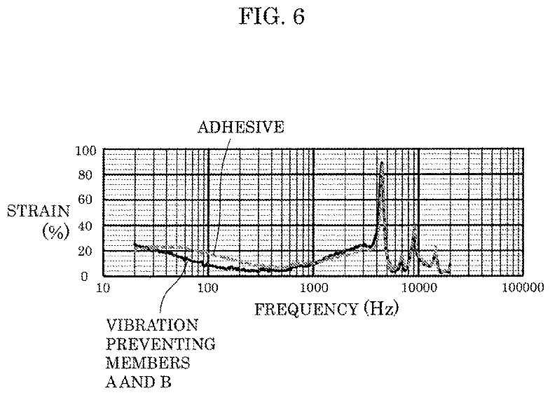

Examples of the material for the viscoelastic body included in vibration preventing member 150 include resins such as acrylic resins, urethane resins, and silicon resins. These resins can have a desired hardness by controlling the type of monomers, the molecular weight of the polymer, and the cross-linking density. The viscoelastic body included in vibration preventing member 150 preferably has a Shore hardness OO in the range of 5 or more and less than 80 at normal temperature (such as 20° C.). A Shore hardness of less than 5 leads to difficulties in handling and thus difficulties in industrial assembling of loudspeaker 100. In contrast, as illustrated in FIG. 4, in the case of a silicon adhesive having a Shore hardness of 80 or more (30 or more in the Shore hardness A), the influences on the acoustic properties are no longer neglectable when the adhesive squeezes out to the curved portion of edge 131. It is believed that this corresponds to the one-digit higher values of the storage modulus and the loss modulus than those of vibration preventing member 150. As shown in the graph of the sound pressure frequency properties in FIG. 5 and the graph of the harmonic distortion properties in FIG. 6, loudspeaker 100 including vibration preventing member 150 having a Shore hardness of 5 and loudspeaker 100 including vibration preventing member 150 having a Shore hardness of 30 have similar properties, which are not distinguishable in the graph. In contrast, it is found that loudspeaker 100 including an adhesive has a reduced sound pressure in a low sound region particular and tends to have stronger distortion in the low sound region compared to loudspeaker 100 including vibration preventing member 150. Accordingly; it is considered that the influences on the acoustic properties caused by the squeeze out can be neglected in vibration preventing member 150 having a Shore hardness of 5 or more and 30 or less.

A sensory test was performed as follows: Vibration preventing member A, vibration preventing member B, and the silicon adhesive were used to produce ten loudspeakers each, and ten testers determined whether a loudspeaker having different sound quality was present among each group of ten loudspeakers. Six testers found a difference in sound quality of the loudspeaker in the case of the adhesive while no tester found such a difference in the loudspeakers including vibration preventing member 150.

As illustrated in the embodiment above, loudspeaker 100 includes magnetic circuit 110 having magnetic gap 111, voice coil body 120 disposed in magnetic gap 111 in an inserted state, diaphragm 130 to which voice coil body 120 is attached, frame 140 to which the outer circumferential portion of diaphragm 130 and magnetic circuit 110 are attached, vibration preventing member 150 including a viscoelastic body attached to the outer circumferential portion of diaphragm 130 in an annular shape, and annular holding member 160 which sandwiches the outer circumferential portion of diaphragm 130 and vibration preventing member 150 between frame 140 and holding member 160.

In such a configuration, vibration preventing member 150, which is a viscoelastic body, seals the gap between frame 140 and holding member 160 to prevent the leakage of the sound from the gap between frame 140 and holding member 160. In addition, vibration preventing member 150 can prevent co-vibration of the outer circumferential portion of diaphragm 130 with frame 140 and holding member 160 by reducing the vibration energy at the fixed end of diaphragm 130 as a result of shear deformation of vibration preventing member 150.

The viscoelastic body included in vibration preventing member 150 preferably has a Shore hardness OO in the range of 5 or more and less than 80.

Such a configuration facilitates the handling of vibration preventing member 150 during assembling of loudspeaker 100, and can effectively reduce the influences on distortion properties. The gap between frame 140 and holding member 160 is completely filled, and the acoustic properties are barely affected even if vibration preventing member 150 reaches the curved portion of edge 131 of diaphragm 130. Accordingly, a fluctuation in acoustic properties between products can be reduced.

Frame 140 may constitute a housing which accommodates magnetic circuit 110 and voice coil body 120.

In such a configuration, vibration preventing member 150 can effectively reduce the vibration of diaphragm 130 transmitted to the entire housing. Accordingly, a loudspeaker having a compact size and having improved sound quality at the same time can be attained.

Moreover, annular edge protector 132 is attached to the outer circumferential portion of diaphragm 130 on the side opposite to vibration preventing member 150. The edge protector with vibration preventing member 150 is disposed between frame 140 and holding member 160.

In such a configuration, diaphragm 130 can be easily held using edge protector 132 harder than diaphragm 130 even if diaphragm 130 is thin and small, improving the efficiency in assembling of the loudspeaker.

### Embodiment 2

An embodiment of diaphragm unit 139 will now be described. Identical reference numerals will be given to identical actions and functions and components (parts) having identical shapes, mechanisms, and structures as in Embodiment 1, and the descriptions thereof will be omitted in some cases. Hereinafter, differences from Embodiment 1 will be mainly described, and the same contents will be omitted in some cases.

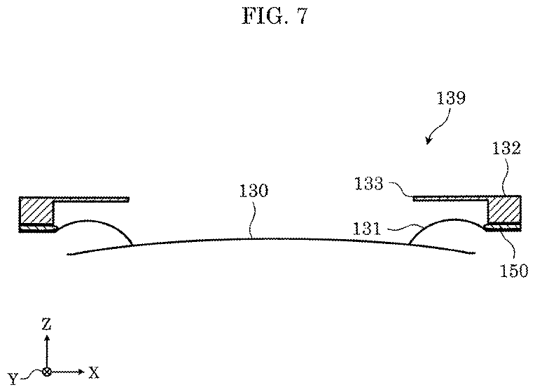

FIG. 7 is a sectional view illustrating a diaphragm unit.

As illustrated in the drawing, diaphragm unit 139 includes diaphragm 130, which is one of components included in loudspeaker 100 as illustrated in Embodiment 1, vibration preventing member 150 including a viscoelastic body attached to the outer circumferential portion of diaphragm 130 in an annular shape, and annular edge protector 132 which is attached to outer circumferential portion of diaphragm 130 and is more rigid than diaphragm 130. In the case of Embodiment 2, to protect edge 131 having the smallest thickness in diaphragm 130, edge protector 132 includes flange 133 which projects inwardly from the outermost circumferential portion of diaphragm 130, to which edge protector 132 is attached, and extends so as to cover the curved portion with a predetermined distance from the curved portion. Vibration preventing member 150 is disposed between the outermost circumferential portion of diaphragm 130 and edge protector 132.

Diaphragm unit 139 can facilitate the handling of diaphragm 130 which is thin and relatively fragile in the inspection stage of diaphragm 130, the circulation stage of diaphragm unit 139, and the assembling stage of loudspeaker 100. By attaching diaphragm unit 139 to loudspeaker 100, the functions of vibration preventing member 150 included in diaphragm unit 139 can be demonstrated.

The present disclosure will not be limited to the embodiments above. For example, the embodiments according to the present disclosure may cover any combination of the components described in this specification or other embodiments including the above components partially excluded. The present disclosure will also include a variety of modifications of the embodiments made by a person skilled in the art without departing from the gist of the present disclosure, that is, within the range not departing from the meanings of the expressions described in Claims.

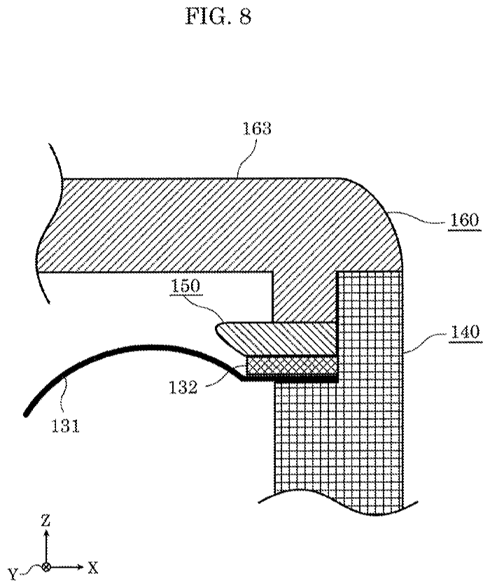

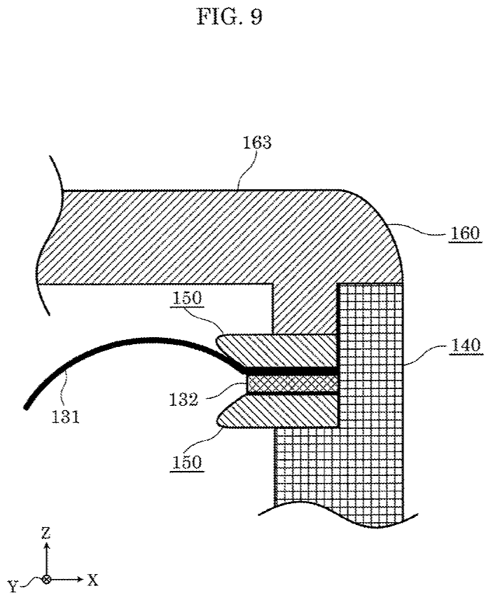

For example, the order of the outermost circumferential portion of diaphragm 130, vibration preventing member 150, and edge protector 132 is not limited to that described in Embodiment 1. For example, as illustrated in FIG. 8, edge protector 132 and vibration preventing member 150 may be disposed at the same position in the outermost circumferential portion of diaphragm 130 between frame 140 and holding member 160.

As above, even if attached to one side of diaphragm 130, vibration preventing member 150 can prevent the vibration of the fixed end of diaphragm 130 to prevent the transmission of the vibration to frame 140. It should be noted that the present disclosure does not exclude the case where vibration preventing member 150 is attached to the front and back sides of diaphragm 130 as illustrated in FIG. 9.

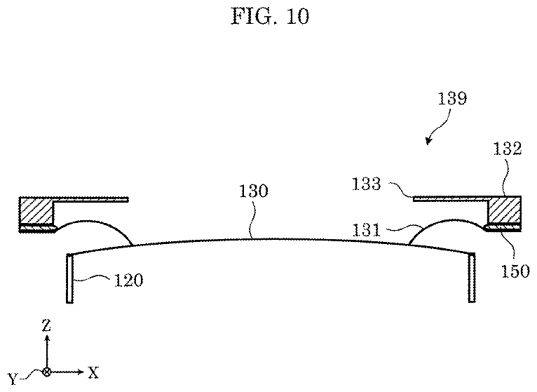

As illustrated in FIG. 10, diaphragm unit 139 may include voice coil body 120 attached to diaphragm 130.

Although the canal earphone has been illustrated as an application example of loudspeaker 100 in Embodiment 1, loudspeaker 100 can also be used in inner ear (in-ear) earphones, clip on earphones, and headphones. Loudspeaker 100 can also be used in moving bodies, portable electronic devices, and the like. Furthermore, loudspeaker 100 may also be used as loudspeaker 100 of a stationary type.

Moreover, diaphragm unit 139 may be integrated with loudspeaker 100 in the state where edge protector 132 including flange 133 is attached to outermost circumferential portion of diaphragm 130.

### INDUSTRIAL APPLICABILITY

The present disclosure is useful as earphones having little change in acoustic properties.

### REFERENCE MARKS IN THE DRAWINGS

100 loudspeaker
110 magnetic circuit
111 magnetic gap
112 magnet
113 top plate
114 yoke
120 voice coil body
130 diaphragm
131 edge
132 edge protector
133 flange
139 diaphragm unit
140 frame
150 vibration preventing member
160 holding member
161 sound path
162 attachment
163 fitting portion
210 ear chip
220 cable

1. A loudspeaker, comprising:
a magnetic circuit having a magnetic gap;
a voice coil body disposed in the magnetic gap in an inserted state;
a diaphragm to which, the voice coil body is attached;
a frame to which an outer circumferential portion of the diaphragm and the magnetic circuit are attached;
a vibration preventing member including a viscoelastic body attached to the outer circumferential portion of the diaphragm in an annular shape; and
a holding member having an annular shape and sandwiching the outer circumferential portion of the diaphragm and the vibration preventing member between the frame and the holding member.

2. The loudspeaker according to claim 1,
wherein the viscoelastic body included in the vibration preventing member has a Shore hardness OO ranging from 5 or more to less than 80.

3. The loudspeaker according to claim 1,
wherein the frame constitutes a housing which accommodates the magnetic circuit and the voice coil body.

4. The loudspeaker according to claim 1, comprising:
an edge protector which has an annular Shape and is attached to the outer circumferential portion of the diaphragm on a side opposite to the vibration preventing member,
wherein the edge protector with the vibration preventing member is disposed between the frame and the holding member.

5. The loudspeaker according to claim 1, comprising:
an edge protector which has an annular shape and is attached to the vibration preventing member such that the vibration preventing member is sandwiched between the outer circumferential portion of the diaphragm and the edge protector;
wherein, the edge protector together with the vibration preventing member is disposed between the frame and the holding member.

6. The loudspeaker according to claim 1,
wherein the holding member forms a sound path which guides a sound to an ear.

7. A diaphragm unit, comprising:
a diaphragm included in a loudspeaker;
a vibration preventing member including a viscoelastic body attached to an outer circumferential portion of the diaphragm in an annular shape; and
an edge protector attached to the outer circumferential portion of the diaphragm, the edge protector being annular and more rigid than the diaphragm.
